(19) United States
(12) Patent Application Publication
(10) Pub. No.: US 2004/0076566 A1
(43) Pub. Date: Apr. 22, 2004

(54) Exhaust treatment unit with a catalyst arrangement and method for the treatment of exhaust gases

(76) Inventors: Stefan Unger, Stuttgart (DE); Wilhelm Polach, Moeglingen (DE)

Correspondence Address: Ronald E Greigg, Greigg & Greigg, Unit One, 1423 Powhatan Street, Alexandria, VA, 22314, US

(21) Appl. No.: 10/399,291

(22) PCT Filed: Oct. 16, 2001
(86) PCT No.: PCT/DE01/03911

(30) Foreign Application Priority Data
Oct. 17, 2000 (DE) 100-51-358.1

(51) Int. Cl. B01D 53/56

(52) U.S. Cl. 423/235; 422/177; 422/172

(57) ABSTRACT

In an exhaust gas cleaning system, having a catalytic converter assembly that includes a storage catalytic converter (1, 10) for reducing nitrogen oxides, and a delivery device (2) for delivering a reducing agent to the inlet side of the storage catalytic converter (1, 10), it is proposed that in order to recirculate at least a portion of the exhaust gas flow leaving the storage catalytic converter (1), a recirculation line (3) be provided, in which an exhaust gas feed pump (4) can be disposed. The exhaust gas recirculation at the storage catalytic converter (1) during the regeneration phase reduces the oxygen content of the exhaust gas and as a result makes it possible to decrease the amount of reducing agent, such as fuel, delivered.

The invention relates to an exhaust gas cleaning system with a catalytic converter assembly, which includes a storage catalytic converter for reducing nitrogen oxides, and with a delivery device for delivering a reducing agent to the inlet side of the storage catalytic converter. The invention also relates to a method for cleaning exhaust gases, in which the exhaust gas is passed through a storage catalytic converter for reducing nitrogen oxides, and for regenerating the storage catalytic converter, a reducing agent is passed through it.

### PRIOR ART

Exhaust gas cleaning systems of this generic type are known in various versions. The storage catalytic converter is used there to store nitrogen oxides (NOₓ) from the exhaust gas flow of an internal combustion engine (Diesel engine) over a certain period of time, which is usually up to about two minutes. The charged catalytic converter must then be evacuated for several seconds. The nitrogen oxides are reduced in the process to nitrogen and are fed back into the exhaust gas. For this evacuation or regeneration operation, a reducing environment (rich mixture) at a prevailing air ratio of lambda<1 is necessary.

An air ratio of lambda<1 can be generated inside the motor directly by controlling combustion, or externally to the motor by metering a reducing agent (such as Diesel fuel) into the exhaust system. Internally in the engine, the ratio of fuel to combustion air is regulated, and a rich mixture (lambda<1) is generated. With this type of regulation, however, combustion with little soot is successfully possible only in the lower rpm/load range. At present, regenerating the storage catalytic converter over the entire performance graph is associated with increased particle emissions or belching soot.

For external regeneration, it is known to introduce a reducing agent in metered fashion into the exhaust gas flow to the storage catalytic converter via a mixer. The regeneration can also be done in the partial flow, and in that case, during the regeneration, the exhaust gas is carried via a bypass line around the storage catalytic converter that is to be evacuated. Finally, a dual system is also known, in which two storage catalytic converters are disposed parallel in the exhaust line. By means of an exhaust gas flap, one storage catalytic converter at a time is charged, while the other storage catalytic converter, decoupled from the exhaust gas flow, is evacuated by supplying the reducing agent.

In this external regeneration, it is the oxygen excess in the exhaust gas that is primarily responsible for a pronounced additional fuel consumption, since the fuel must be catalytically combusted during the regeneration if air ratios below 1.0 are to be attained.

Because of the high nitrogen oxide emissions in the upper rpm/load range, the charging times for the storage catalytic converters are so short that frequent regeneration cycles are required. In conjunction with the oxygen excess in the exhaust gas, the result is a pronounced additional fuel consumption. The aforementioned dual system comprising two parallel-connected storage catalytic converters does allow alternating charging and evacuation of the catalytic converters and thus continuous exhaust gas cleaning, but it does not solve the problem of the oxygen excess in the exhaust gas and of the elevated fuel consumption.

The object of the present invention is therefore to disclose an exhaust gas cleaning system of the generic type in question that overcomes the aforementioned problem of the additional fuel consumption in catalytic converter assemblies with storage catalytic converters that have to be regenerated, and also to disclose a corresponding exhaust gas cleaning method.

This object is attained by the characteristics of claims 1 and 9, respectively. Advantageous features will become apparent from the respective dependent claims.

### ADVANTAGES OF THE INVENTION

The invention, in an exhaust gas cleaning system with a catalytic converter assembly that includes a storage catalytic converter and with a delivery device for delivering a reducing agent to the storage catalytic converter, proposes disposing a recirculation line, through which at least a portion of the exhaust gases leaving the storage catalytic converter can be returned, i.e. recirculated, to the inlet side of this storage catalytic converter.

In the exhaust gas cleaning method of the invention, in the regeneration phase of the storage catalytic converter at least a portion of the exhaust gases leaving this storage catalytic converter are recirculated to its inlet.

The effect of the invention is that during the regeneration of the storage catalytic converter, the oxygen content in the exhaust gas can be lowered by recirculating a portion of the exhaust gases to the catalytic converter. By suitable design of the recirculated partial flow, the oxygen content in the exhaust gas can be lowered in a defined way during the regeneration phase. Lowering the oxygen content reduces the additional fuel consumption, compared to previous systems without exhaust gas recirculation, since markedly less reducing agent (fuel) is needed to eliminate the oxygen.

It is advantageous to insert a feed pump into the recirculation line in the exhaust gas cleaning system of the invention. The exhaust gas can then be recirculated to the catalytic converter at a predetermined pressure and/or in a predetermined amount.

A check valve can prevent a short-circuit flow by way of the recirculation line.

So that during the regeneration phase only at most a partial flow of the engine exhaust gas to be cleaned will be carried to the storage catalytic converter, it is useful to set up a bypass line that extends parallel to this catalytic converter; via an exhaust gas flap, the respective inflow to the storage catalytic converter and into the bypass line can be adjusted.

To assure continuous exhaust gas cleaning even during the relatively brief regeneration time, it is advantageous to incorporate a further catalytic converter into the bypass line or into a parallel line. This catalytic converter can in turn be a storage catalytic converter or a known denox catalytic converter. If a further catalytic converter is used, it can be provided for recirculating a partial flow of exhaust gas during its regeneration via its own recirculation line.

However, it is advantageous, in a dual system comprising two storage catalytic converters, to use only one recirculation line, with which the two storage catalytic converters communicate via exhaust gas flaps. Depending on the position of these exhaust gas flaps, a portion of the exhaust gas can be recirculated to one of the two storage catalytic converters. With this arrangement, a recirculation line and other components that may optionally be present, such as a metering device for the reducing agent, a feed pump, and/or a catalytic mixer, can be omitted. Using a single common exhaust gas recirculation line for regeneration is especially appropriate, since simultaneous regeneration of both storage generators is to be avoided anyway, so as to assure continuous exhaust gas cleaning.

The exhaust gas cleaning system of the invention can also be used for continuous storage catalytic converters. These storage catalytic converters function with a rotatable perforated baffle, by way of which the reducing agent is introduced into the exhaust gas flow. The perforated baffle sweeps over the entire cross-sectional area of the storage catalytic converter, so that after one complete revolution, one regeneration phase has taken place.

To use this kind of continuous storage catalytic converter in the exhaust gas cleaning system of the invention, a portion of the emerging exhaust gases is recirculated during the regeneration phase to the perforated baffle, through which the reducing agent is metered in, and it is appropriate to rotate the storage catalytic converter about an axis in such a way that its entire cross-sectional area can be swept—as is the case upon rotation of the perforated baffle. It is also appropriate to dispose the recirculation line in the particular partial flow that is subjected to the reducing agent at the inlet side of the storage catalytic converter.

It is advantageous, downstream of the storage catalytic converter and the recirculation line and of other lines that may be connected parallel to them, to insert an oxidation catalytic converter into the exhaust line. The oxidation catalytic converter can prevent a breakthrough of HC and CO, by oxidizing uncombusted hydrocarbon components in the exhaust gas flow.

It is also advantageous to provide a catalytic mixer downstream of the point where the reducing agent is delivered into the exhaust gas flow. By this means, the reducing agent can be cracked and better mixed.

For reaching the lightoff temperature of the catalytic converter faster, reducing agent (fuel) can be metered into the exhaust gas flow, especially during the warmup phase, in order to raise the catalytic converter temperature.

Since the invention takes an external regeneration principle as its point of departure, no throttle valve is needed in the engine during the regeneration phase, and direct intervention into the engine regulation is unnecessary.

The invention permits the regeneration of storage catalytic converters, with a drastic lessening of the additional consumption of reducing agent/fuel.

### DRAWINGS

The invention will be described in further detail below in terms of exemplary embodiments illustrated in the accompanying drawings.

FIG. 1 shows a first embodiment of the exhaust gas cleaning system of the invention.

FIG. 2 shows a further embodiment (dual system) of the exhaust gas cleaning system of the invention.

FIG. 3 schematically shows a continuous-operation storage catalytic converter that can be used for the exhaust-gas cleaning system of the invention; and

FIG. 4 shows the continuous-operation storage catalytic converter of FIG. 3 in a front view.

### DESCRIPTION OF THE PREFERRED EMBODIMENTS

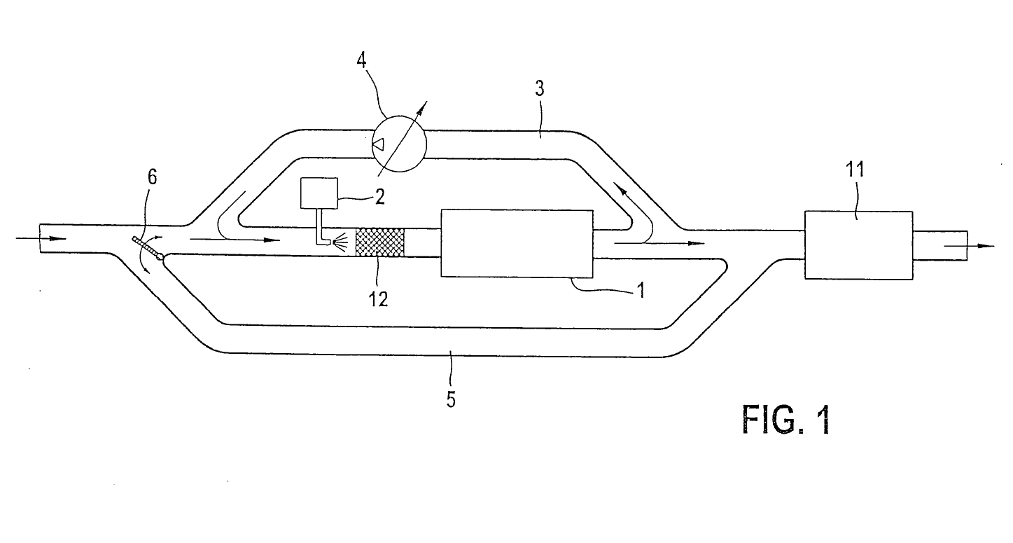

FIG. 1 schematically shows a first embodiment of an exhaust gas cleaning system of the invention. Exhaust gases arriving from an internal combustion engine or Diesel engine, not shown, are catalytically cleaned. These exhaust gases are composed primarily of nitrogen, carbon dioxide, and water, and to a slight extent, pollutants. These pollutants include carbon monoxide, uncombusted hydrocarbons, nitrogen oxides, and particles (soot). By means of oxidation catalytic converters, incompletely combusted ingredients, both CO and HC (hydrocarbons), are oxidized into carbon dioxide and water. Existing nitrogen oxides are eliminated by reduction-type catalytic converters. For that purpose, conventional active denox catalytic converters and/or storage catalytic converters are used. The latter, that is, storage catalytic converters, can take up nitrogen oxides over a certain period of term (up to about two minutes) and then must be regenerated for a relatively short period (several seconds). In this regeneration, the nitrogen oxides are reduced to nitrogen and are fed back to the exhaust gas flow. This reduction process requires a low-oxygen environment (rich mixture) at an air ratio of lambda<1, and for that purpose a reducing agent is metered into the exhaust gas flowing to the storage catalytic converter. Fuel is often used as the reducing agent.

To economize on the reducing agent/fuel delivered while simultaneously lowering the oxygen content in the exhaust gas that is delivered to the storage catalytic converter during the regeneration, an exhaust gas cleaning system of the invention as shown in FIG. 1 is suitable. It comprises a storage catalytic converter 1 with a delivery device 2 for delivering a reducing agent and with a downstream catalytic mixture 12 for mixing and cracking the delivered reducing agent. Via a recirculation line 3, according to the invention a portion of the exhaust gas flow leaving the storage catalytic converter 1 can be recirculated to the inlet side thereof. An exhaust gas feed pump 4 is provided in the recirculation line 3. An exhaust-gas flap 6 regulates the inflow of exhaust gases to the storage catalytic converter on the one hand and into the bypass line 5, extending parallel to it, on the other. This arrangement is followed downstream by an oxidation catalytic converter 11.

In the normal situation, the storage catalytic converter 1 is charged with the bypass line 5 closed by the exhaust gas flap 6. For regenerating the storage catalytic converter 1, the exhaust gas flap 6 is adjusted in such a way that now only a partial flow reaches the catalytic converter. For optimal adjustment of the partial flow of exhaust gas, the exhaust gas flap can be adjusted as a function of the operating conditions or the operating point by means of EDC. With the aid of a metering system 2, the reducing agent, in this case Diesel fuel, is injected into the exhaust gas. The downstream catalytic mixer 12 mixes the reducing agent with the exhaust gas and initiates the first cracking and oxidation processes.

By means of an exhaust gas feed pump 4 in the recirculation line 3, the exhaust gas recirculation takes place at the catalytic converter 1, in order to lower the oxygen concentration in the exhaust gas during the regeneration. The exhaust gas feed pump 4 is equipped with a check valve, to prevent a short-circuit flow via the recirculation line 3, bypassing the storage catalytic converter 1, during the charging of the storage catalytic converter 1.

In the system shown, during the regeneration the main flow of exhaust gas bypasses the storage catalytic converter 1 through the bypass line 5. A downstream oxidation catalytic converter 11 prevents an HC breakthrough.

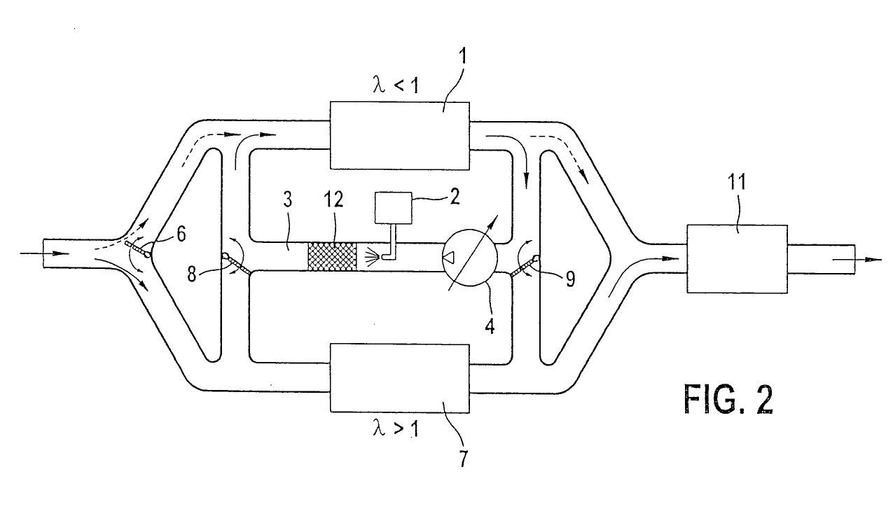

Another variant of the exhaust gas cleaning system of the invention is shown schematically in FIG. 2. This is a dual system comprising two parallel storage catalytic converters 1 and 7. While one storage catalytic converter 1, 7 is charged, the regeneration takes place in the second storage catalytic converter 7, 1 in the partial flow of exhaust gas. Parallel charging of the storage catalytic converters 1 and 7 is possible, but the charging state of the two catalytic converters should be different. Those components that correspond to those of FIG. 1 are identified by the same reference numerals.

Both storage catalytic converters 1, 7 have a joint recirculation line 3 for recirculating an exhaust gas partial flow. In this recirculation line 3, as additional components (as in FIG. 1), a metering system 2, a catalytic mixer 12, and an exhaust gas pump 4 are provided. An exhaust gas flap 6 regulates the inflow of exhaust gas to the storage catalytic converter 1 and to the storage catalytic converter 7. In this embodiment as well, an oxidation catalytic converter 11 is connected downstream of the two catalytic converters.

Analogously to the embodiment of FIG. 1, during the regeneration, an exhaust gas recirculation takes place solely at the storage catalytic converter that is to be evacuated. By means of two further exhaust gas flaps 8 and 9, the recirculation line 3 can be associated with whichever storage catalytic converter 1, 7 is to be regenerated. Thus only a single metering system 2, catalytic mixer 12 and exhaust gas feed pump 4 suffice for both storage catalytic converters 1 and 7.

The advantage of the dual system is also the absence of a bypass flow during the regeneration phase, so that continuous exhaust gas cleaning is possible.

In principle, it would also be possible to equip each individual storage catalytic converter 1, 7 with its own exhaust gas recirculation line including a reducing agent delivery device. By that means, it would be possible to dispense with the two exhaust gas flaps 8 and 9.

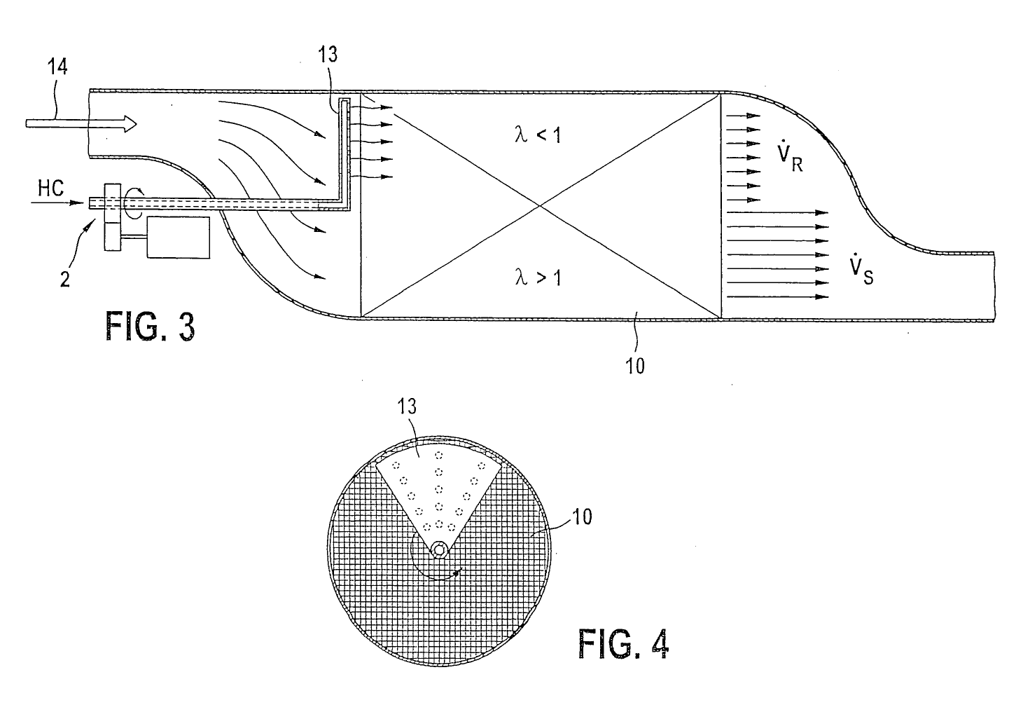

FIG. 3 shows a continuous-operation storage catalytic converter 10 with a delivery device 2 for delivering a reducing agent (HC). The delivery device is shown again in FIG. 4 in a front view of the cross-sectional area of the storage catalytic converter 10. The delivery device 2 essentially comprises a perforated baffle 13, which is disposed rotatably, so that the entire cross-sectional area of the storage catalytic converter 1 can be swept. The delivery of reducing agent to the perforated baffle is effected coaxially to the pivot axis via a line.

The arrow 14 represents the inflow direction of the exhaust gases. The reducing agent emerging from the perforated baffle is engaged by the exhaust gas flow and passed through the interior of the storage catalytic converter 10. There, a reducing atmosphere (lambda<1) is established, so that stored nitrogen oxides are reduced to nitrogen and leave the storage catalytic converter 10 in the form of a volumetric flow V_{R}. As a result of the region not covered by the perforated baffle 13, the exhaust gases flow into the interior of the storage catalytic converter 10, which as a result becomes charged with nitrogen oxides. After a storage time that is dependent on the speed of rotation of the perforated baffle, the regeneration phase follows. The exhaust gas flow cleaned of nitrogen oxides leaves the catalytic converter 10 in the form of a volumetric flow V_{S}.

In order to implement the invention with this type of continuous-operation storage catalytic converter, a portion of the exhaust gas flow, in particular the exhaust gas flow V_{R}, is recirculated to the perforated baffle 13. To make it possible for the recirculation line and the perforated baffle 13 to be kept stationary, the storage catalytic converter, instead of the perforated baffle, is advantageously rotated about its longitudinal axis.

The embodiments described illustrate the possibility of using the invention in existing catalytic converter assemblies. The invention reduces the additional fuel consumption in catalytic converter assemblies with storage catalytic converters without requiring intervention into the regulation of the engine combustion.

1. An exhaust gas cleaning system, having a catalytic converter assembly that includes a storage catalytic converter (1, 10) for reducing nitrogen oxides, and a delivery device (2) for delivering a reducing agent to the inlet side of the storage catalytic converter (1, 10),
characterized in that
a recirculation line (3) for recirculating at least a portion of the exhaust gas flow, leaving the storage catalytic converter (1, 10), to the input side of the storage catalytic converter (1, 10) is provided.

2. The exhaust gas cleaning system of claim 1, characterized in that a feed pump (4) is provided in the recirculation line (3).

3. The exhaust gas cleaning system of claim 1 or 2, characterized in that a check valve is provided in the recirculation line (3).

4. The exhaust gas cleaning system of one of claims 1-3, characterized in that a bypass line (5) extending parallel to the storage catalytic converter (1, 10) is provided, and the inflow to the storage catalytic converter (1, 10) and into the bypass line (5) is adjustable via an exhaust gas flap (6).

5. The exhaust gas cleaning system of claim 4, characterized in that a further catalytic converter is present in the bypass line (5).

6. The exhaust gas cleaning system of one of claims 1-5, characterized in that a further storage catalytic converter (7) is connected parallel to the storage catalytic converter (1, 10), and via an exhaust gas flap (6), the inflow to both storage catalytic converters (1, 10; 7) can be adjusted, and that the further storage catalytic converter (7) communicates via exhaust gas flaps (8, 9) with the recirculation line (3) for recirculating exhaust gases from the first storage catalytic converter (1, 10), in such a way that at least a portion of the exhaust gas flow leaving the further storage catalytic converter (7) can be recirculated to the inlet side of that storage catalytic converter.

7. The exhaust gas cleaning system of one of claims 1-6, characterized in that at least one continuously operating storage catalytic converter (10) is provided, and the delivery device (2) for delivering a reducing agent and the recirculation line (3) for recirculating exhaust gases are mounted in stationary fashion, and the storage catalytic converter (10) is disposed rotatably about an axis in such a way that via the delivery device (2), reducing agent can be delivered over the entire inflow cross-sectional area of the storage catalytic converter (10).

8. The exhaust gas cleaning system of one of claims 1-7, characterized in that an oxidation catalytic converter (11) is provided downstream of the storage catalytic converter or converters (1, 10; 7) in the exhaust line.

9. A method for cleaning exhaust gases, in which the exhaust gas is passed through a storage catalytic converter (1, 10) for reducing nitrogen oxides, and in which for regenerating the storage catalytic converter a reducing agent is passed through it, characterized in that during the regeneration, at least a portion of the exhaust gases leaving the storage catalytic converter is recirculated to the inlet side of the storage catalytic converter.

10. The method of claim 9, characterized in that during the regeneration, a portion of the exhaust gases is passed through the storage catalytic converter (1, 10), while the other portion is passed through a bypass line (5) that bypasses the storage catalytic converter (1, 10).

11. The method of claim 10, characterized in that in which the portion passed through the bypass line (5) is passed through a further catalytic converter.

12. The method of one of claims 9-11, characterized in that in addition a further, parallel-connected storage catalytic converter (7) is used, and that the storage catalytic converters (1, 10; 7) are charged and regenerated in alternation.

13. The method of one of claims 9-12, characterized in that a continuously operating storage catalytic converter is used, which is acted upon in part by a reducing agent and for the remaining part with exhaust gas to be cleaned, and a recirculation of exhaust gases to the part of the storage catalytic converter (10) that is acted upon by the reducing agent is effected, while the storage catalytic converter (10) is rotated about an axis parallel to the flow direction.
